(19) United States
(12) Patent Application Publication
(10) Pub. No.: US 2022/0252636 A1
(43) Pub. Date: Aug. 11, 2022

(54) ACCELEROMETER APPARATUSES AND SYSTEMS

(71) Applicant: Kionix, Inc., Ithaca, NY (US)

(72) Inventors: Wenting GU, Ithaca, NY (US); Andrew HOCKING, Ithaca, NY (US); Nicole KERNESS, Ithaca, NY (US)

(21) Appl. No.: 17/591,092

(22) Filed: Feb. 2, 2022

Related U.S. Application Data
(60) Provisional application No. 63/146,344, filed on Feb. 5, 2021.

(51) Int. Cl. G01P 15/125; G01P 15/18; G01P 15/08

(52) U.S. Cl. CPC G01P 15/125; G01P 15/0802; G01P 15/18

(57) ABSTRACT

A sensor having a proximal end and a distal end includes an anchor, a proof mass, a fixed finger, and a movable finger. The anchor is disposed at the proximal end. The proof mass is coupled to the anchor and disposed at a first distance from the anchor. The fixed finger and the movable finger are coupled to the anchor and disposed at a second distance from the anchor at the distal end. The fixed and movable fingers are configured to measure a first capacitance area. A ratio of the first distance over the second distance is between about 0.2 to about 0.6. The ratio is configured to deflect the movable finger at least about 1 μm relative to the fixed finger.

### CROSS REFERENCE TO RELATED APPLICATION

This application claims priority to U.S. Provisional Application No. 63/146,344, filed Feb. 5, 2021, which is hereby incorporated herein in its entirety by reference.

### BACKGROUND

### Field

The present disclosure relates to sensor apparatuses and systems, for example, accelerometer apparatuses and systems.

### Background

A microelectromechanical system (MEMS) can be fabricated using semiconductor device fabrication technologies. MEMS utilizes microelectronic processing techniques to reduce mechanical components down to the scale of microelectronics. MEMS can integrate mechanical sensor elements and their associated signal processing electronics into a single chip in a common manufacturing process. MEMS can be used for various devices including accelerometers, gyroscopes, inertial measurement units, digital micromirrors, optical switching units, pressure sensors, microphones, resonators, or magnetometers. For example, accelerometer elements constructed using MEMS include structures similar to a standard accelerometer: a proof mass, restoring springs, a displacement transducer, and a case to which everything is attached. Such a MEMS accelerometer can be wire bonded to an integrated circuit (IC), for example, a microprocessor, a microcontroller, and/or an Application Specific Integrated Circuit (ASIC). A MEMS and an IC can be packaged in a packaging unit typically constructed of three components: (1) a MEMS sensor that senses a parameter, e.g., acceleration; (2) electronics included in an IC that transduces the MEMS sensor's response to the parameter into an electronic signal; and (3) a package that houses the MEMS sensor and the IC.

MEMS sensors (e.g., an accelerometer) can suffer from low amplification of sense motion, noise, or damage or failure (e.g., immobility). For a Z-axis accelerometer, a large depth (e.g., along a Z-axis) sense region (e.g., fingers) is susceptible to low amplification of sense motion due to a large mass and a small moment arm. Further, a Z-axis accelerometer is susceptible to high noise due to a large capacitance of the sense region (e.g., large area). Additionally, a Z-axis accelerometer is susceptible to damage or failure due to deflection of the sense region and resulting contact with a floor, a ceiling, or other components of the sensor during high-g shock conditions.

### SUMMARY

Accordingly, there is a need for improved MEMS that can increase amplification of sense motion, better reduce overall noise in the sensor, and/or reduce the risk of device damage or failure.

In some embodiments, a sensor having a proximal end and a distal end includes an anchor, a proof mass, a fixed finger, and a movable finger. The anchor is disposed at the proximal end. The proof mass is coupled to the anchor and disposed at a first distance from the anchor. The fixed finger and the movable finger are coupled to the anchor and disposed at a second distance from the anchor at the distal end. The fixed and movable fingers are configured to measure a first capacitance area. A ratio of the first distance over the second distance is between about 0.2 to about 0.6. The ratio is configured to deflect the movable finger at least about 1 μm relative to the fixed finger.

In some embodiments, the ratio is between about 0.25 to about 0.45 and is configured to deflect the movable finger at least about 3 μm relative to the fixed finger. In some embodiments, the ratio is between about 0.25 to about 0.45 and is configured to reduce a noise density of the sensor to no greater than about 130 μg Hz^{-1/2}.

In some embodiments, the sensor further includes a bowed region between the fixed and movable fingers and the anchor. In some embodiments, the bowed region includes a linkage configured to lower a stiffness of the movable finger. In some embodiments, the fixed and movable fingers extend along a portion of the bowed region.

In some embodiments, the fixed finger includes a first height and the movable finger comprises a second height. In some embodiments, the first and second heights are no greater than about 15 microns. In some embodiments, the first and second heights are offset from each other by a height difference.

In some embodiments, the fixed finger includes a plurality of fixed comb fingers and the movable finger includes a plurality of movable comb fingers.

In some embodiments, the sensor further includes a second fixed finger and a second movable finger disposed between the first and second distances and configured to measure a second capacitance area.

In some embodiments, the proof mass includes a first proof mass and a second proof mass. In some embodiments, the movable finger has a resonant frequency of about 5 kHz to about 15 kHz. In some embodiments, the sensor is a Z-axis accelerometer.

In some embodiments, a sensor system includes a first sensor and a second sensor adjacent the first sensor. The first sensor includes a proof mass and a first sense structure. The first sense structure has a first height perpendicular to a longitudinal axis of the first sensor and is coupled to the proof mass. The first sense structure includes a fixed finger and a movable finger and is configured to measure capacitance area changes between the fixed and movable fingers. The second sensor includes a second sense structure having a second height perpendicular to the longitudinal axis of the first sensor. The first height is less than the second height and is configured to reduce a noise density in the sensor system.

In some embodiments, the first height is no greater than about 15 microns. In some embodiments, the second sensor is disposed between the proof mass and the first sense structure of the first sensor. In some embodiments, the first sensor is a Z-axis accelerometer and the second sensor is an X-axis accelerometer or a Y-axis accelerometer.

In some embodiments, a differential sensor system includes a first sensor system, a second sensor system, and a processor coupled to the first and second sensor systems. The first sensor system includes a first sensor and a second sensor. The first sensor includes a first sense structure having a first height perpendicular to a longitudinal axis of the first sensor and coupled to a proof mass. The first sense structure is configured to measure capacitance area changes between a fixed comb finger and a bowed movable comb finger. The second sensor includes a second sense structure having a second height perpendicular to the longitudinal axis of the first sensor. The first height is less than the second height. The second sensor system includes a third sensor and a fourth sensor. The third sensor includes a third sense structure having a third height perpendicular to a longitudinal axis of the third sensor and coupled to a second proof mass. The third sense structure is configured to measure capacitance area changes between a bowed fixed comb finger and a movable comb finger. The fourth sensor includes a fourth sense structure having a fourth height perpendicular to the longitudinal axis of the third sensor. The third height is less than the fourth height. The processor is coupled to the first and second sensor systems. The processor is configured to measure a differential measurement between the first and second sensor systems.

In some embodiments, the second sensor is disposed between the proof mass and the first sense structure of the first sensor. In some embodiments, the fourth sensor is disposed between the second proof mass and the third sense structure of the third sensor.

In some embodiments, the first sensor is a Z-axis accelerometer. In some embodiments, the second sensor is an X-axis accelerometer or a Y-axis accelerometer. In some embodiments, the third sensor is a Z-axis accelerometer. In some embodiments, the fourth sensor is an X-axis accelerometer or a Y-axis accelerometer.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a schematic top view illustration of a sensor, according to an embodiment.

FIG. 2 is a schematic longitudinal cross-sectional illustration of the sensor of FIG. 1, according to an embodiment.

FIG. 3 is a schematic transverse cross-sectional illustration of a sense structure of the sensor of FIG. 1, according to an embodiment.

FIG. 4 is an enlarged partial schematic top view illustration of the sense structure of FIG. 1, according to an embodiment.

FIG. 5 is an enlarged partial schematic perspective view illustration of the sense structure of FIG. 4, according to an embodiment.

FIG. 6 is a schematic top view illustration of a sensor, according to an embodiment.

FIG. 7 is a schematic top view illustration of a sensor system, according to an embodiment.

FIG. 8 is a schematic top view illustration of a sensor, according to an embodiment.

FIG. 9 is a schematic top view illustration of a sensor system, according to an embodiment.

FIG. 10 is a schematic longitudinal cross-sectional illustration of the sensor system of FIG. 7, according to an embodiment.

FIG. 11 is a schematic longitudinal cross-sectional illustration of the sensor system of FIG. 9, according to an embodiment.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment,” “an embodiment,” “an example embodiment,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Spatially relative terms, such as “beneath,” “below,” “lower,” “above,” “on,” “upper,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The term “about” or “substantially” as used herein indicates the value of a given quantity that can vary based on a particular technology. Based on the particular technology, the term “about” or “substantially” can indicate a value of a given quantity that varies within, for example, 1-15% of the value (e.g., ±1%, ±2%, ±5%, ±10%, or ±15% of the value).

Embodiments of the disclosure may be implemented in hardware, firmware, software, or any combination thereof. Embodiments of the disclosure may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, and/or instructions may be described herein as performing certain actions. However, it should be appreciated that such descriptions are merely for convenience and that such actions in fact result from computing devices, processors, controllers, or other devices executing the firmware, software, routines, instructions, etc.

Exemplary Sensors

As discussed above, MEMS sensors (e.g., an accelerometer) can suffer from low amplification of sense motion, noise, or damage or failure (e.g., immobility). For a Z-axis accelerometer, a large depth (e.g., along a Z-axis) sense structure (e.g., fingers) is susceptible to low amplification of sense motion due to a large mass and small moment arm. Sense motion in a sensor (e.g., Z-axis accelerometer) can be increased by using certain ratios of a length of the proof mass moment arm and a length of the sense structure moment arm.

Sense motion amplification in a sensor with a proof mass (Mₚ) having a moment arm (rₚ) from an anchor and a sense structure mass (mₛ) having a moment arm (rₛ) from the anchor can be approximated as a damped harmonic oscillator:

$$I \frac{{d}^{2} θ}{d {t}^{2}} + C \frac{d θ}{d t} + {K}_{t} θ = T .$$

At lower frequencies, the approximation reduces to Kₜθ=T. Substituting in the rotational kinetic energy (Kₜ) gives: (Iω²)θ=T. Substituting in the moment of inertia (I) and potential energy (T) gives: (mₛrₛ²+Mₚrₘ²)ω²θ=(mₛgrₛ+Mₚgrₚ). Rearranging gives the displacement and sensitivity of the sense structure:

$${r}_{s} θ = \frac{{m}_{s} {gr}_{s}^{2} + {M}_{p} {gr}_{p} {r}_{s}}{{ω}^{2} ( {m}_{s} {r}_{s}^{2} + {M}_{p} {r}_{m}^{2} )} = \frac{g}{{ω}^{2}} \frac{( {c}_{1}^{2} + {c}_{1} {c}_{2} )}{( {c}_{1}^{2} + {c}_{2} )} ,$$

where

$${c}_{1} = \frac{{r}_{s}}{{r}_{p}} and {c}_{2} = \frac{{M}_{p}}{{m}_{s}} .$$

Hence, for a fixed natural frequency (ω), the sensitivity of the sense structure is proportional to

$$\frac{( {c}_{1}^{2} + {c}_{1} {c}_{2} )}{( {c}_{1}^{2} + {c}_{2} )} ,$$

which shows that sensitivity increases with

$${c}_{2} = \frac{{M}_{p}}{{m}_{s}} \approx {M}_{p}$$

and that sensitivity for

$$\frac{1}{{c}_{1}} = \frac{{r}_{p}}{{r}_{s}}$$

equal to about 0.2 to about 0.6, for example, 0.35. Thus, as the mass (e.g., size) of the proof mass (Mₚ) is increased, the sensitivity (e.g., precision, accuracy) of the sensor also increases proportionally. Additionally, the sensitivity of the sensor can be maximized when the moment arm (rₚ) length of the proof mass (Mₚ) over the moment arm (rₛ) length of the sense structure mass (mₛ) is tuned to about 0.35.

Also, sense motion can be amplified by creating a bowed region (e.g., bowed movable fingers) in the sensor such that bowed movable fingers are offset from fixed fingers, for example, of the same height (e.g., along a Z-axis), in the sense structure. For example, this can be accomplished by depositing a different material (e.g., silicon oxide) with a different coefficient of thermal expansion (CTE) atop the movable fingers material (e.g., silicon). The movable fingers will bend or bow due to the difference in CTE and can form a height offset with adjacent fixed fingers in the sense structure.

Further, a Z-axis accelerometer is susceptible to high noise due to a large capacitance of the sense structure (e.g., large area) that acts as a transducer to measure sense motion (e.g., acceleration) of, for example, the bowed movable fingers. Noise in a sensor (e.g., Z-axis accelerometer) can be reduced by decreasing the capacitance of a sense structure performing the sense measurement (e.g., area-varying capacitive sensing). The capacitance (C₀) is a function of the overlapping area between the fixed fingers and the bowed movable fingers. Hence, noise in the sensor can be reduced by decreasing the overlapping area (e.g., a height) of the sense structure.

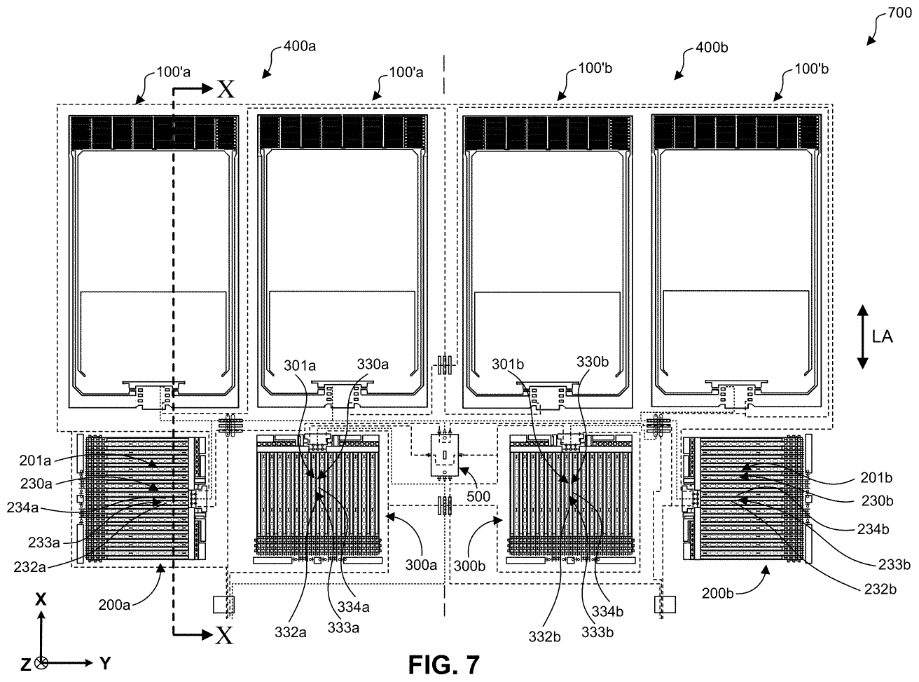

Additionally, a Z-axis accelerometer is susceptible to damage or failure due to deflection of the sense structure and resulting contact with a floor, a ceiling, or other components of the sensor during high-g shock conditions. Damage or failure (e.g., immobility) in a sensor (e.g., Z-axis accelerometer) can be reduced by decreasing a height of the sense structure, for example, relative to larger sense structure heights used in other sensors (e.g., X-axis accelerometer, as shown in FIGS. 7, 9, 10, and 11). For example, by decreasing the height of the sense structure to no greater than about 15 μm, a noise density of the sensor can be reduced to no greater than about 130 μg Hz^{-1/2}. For example, a sense structure height of about 50 μm (e.g., X-axis accelerometer, as shown in FIGS. 7, 9, 10, and 11) gives a larger noise density of about 350 μg Hz^{-1/2}.

Embodiments of this disclosure provide a MEMS sensor (e.g., an accelerometer). In some embodiments, the MEMS sensor has increased sense motion amplification due to a lower height (e.g., along a Z-axis) of a sense structure. In some embodiments, the MEMS sensor has increased sense motion amplification due to a moment arm ratio of a proof mass and the sense structure. In some embodiments, the MEMS sensor has an overall reduced noise due to a lower height (e.g., along a Z-axis) of the sense structure. For example, a noise density of the sensor can be reduced to no greater than about 130 μg Hz^{-1/2}. In some embodiments, the MEMS sensor has an overall reduced noise due to area-varying capacitive sensing of fixed fingers and bowed movable fingers in the sense structure (e.g., or vice versa, bowed fixed fingers and movable fingers). In some embodiments, the MEMS sensor has a reduced risk of device damage or failure due to a lower height (e.g., along a Z-axis) of the sense structure.

In some embodiments, a sensor can include an anchor, a proof mass coupled to the anchor and disposed at a first distance from the anchor, and a fixed finger and a movable finger in a sense structure coupled to the anchor and disposed at a second distance from the anchor. The anchor can be configured to be fixed (e.g., to a substrate) and can support the proof mass and sense structure in a suspended fashion. The proof mass can provide a reference resonant frequency. The sense structure can transduce a movement and can measure a parameter. For example, the sense structure can provide an area-varying capacitive measurement between a fixed finger(s) and a movable finger(s). For example, fixed fingers can be spatially fixed and movable fingers can freely move relative to the fixed fingers when accelerated to cause a directional change in overlapping capacitance area (e.g., measurable change in capacitance area). In some embodiments, the MEMS sensor can be a resonating device (e.g., an accelerometer) that can oscillate at its resonant frequency.

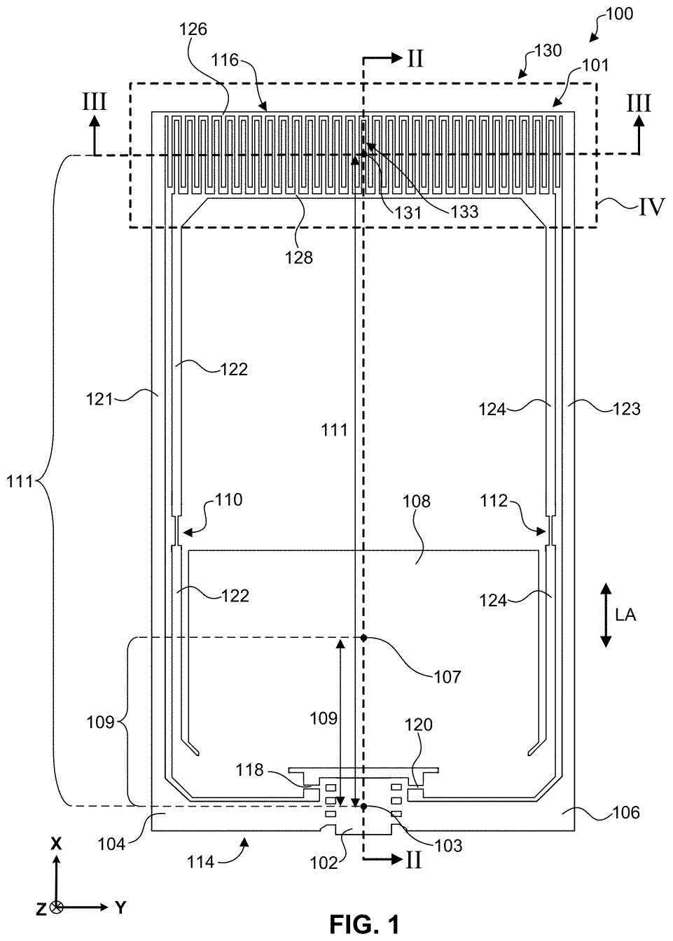

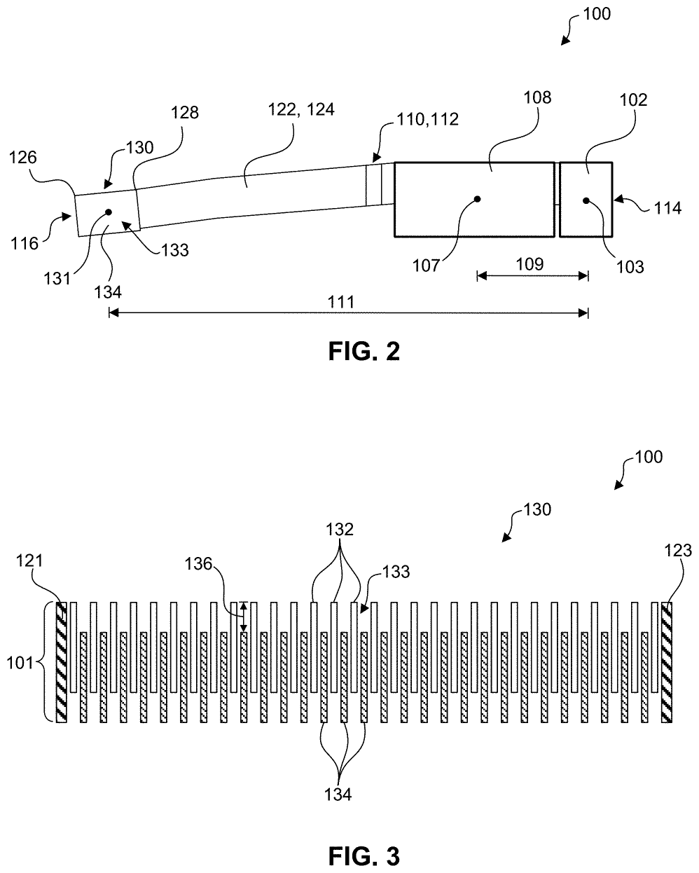

FIGS. 1-5 illustrate schematics of a MEMS sensor 100, according to exemplary embodiments. FIG. 1 illustrates a schematic top view of sensor 100. FIG. 2 illustrates a schematic cross-sectional view of sensor 100 along longitudinal axis (LA). Sensor 100 can be configured to be a low noise density, area-varying capacitive MEMS sensor with a bowed region (e.g., bowed movable fingers) and a reduced sensor structure height (e.g., no greater than 15 μm). In some embodiments, sensor 100 can be a Z-axis accelerometer. In some embodiments, sensor 100 can include an accelerometer, a gyroscope, a pressure sensor, a resonator, or a magnetometer. In some embodiments, sensor 100 can have a mass of about 5 μg to about 7 μg. In some embodiments, sensor 100 can have a resonant frequency of about 5 kHz to about 15 kHz. In some embodiments, sensor 100 can be made of a semiconductor material, for example, silicon.

As shown in FIG. 1, sensor 100 can include anchor 102, first frame 104, second frame 106, proof mass 108, first frame leg 121, first finger leg 122, second frame leg 123, second finger leg 124, and a sense structure 130. Sensor 100 can define a longitudinal axis (LA) extending between a proximal end 114 and a distal end 116 of sensor 100. Anchor 102 can be disposed at proximal end 114 of sensor 100. Anchor 102 can be configured to be fixed (e.g., to a substrate) and can be coupled to first and second frames 104, 106 and be coupled to proof mass 108 via first and second anchor linkages 118, 120. First and second frames 104, 106 can be configured to couple or to link sense structure 130 to anchor 102, for example, to link sense structure distal end 126 and fixed fingers 132 to anchor 102. First and second anchor linkages 118, 120 can function as springs and can be configured to reduce stiffness and allow proof mass 108 to oscillate at a natural resonant frequency.

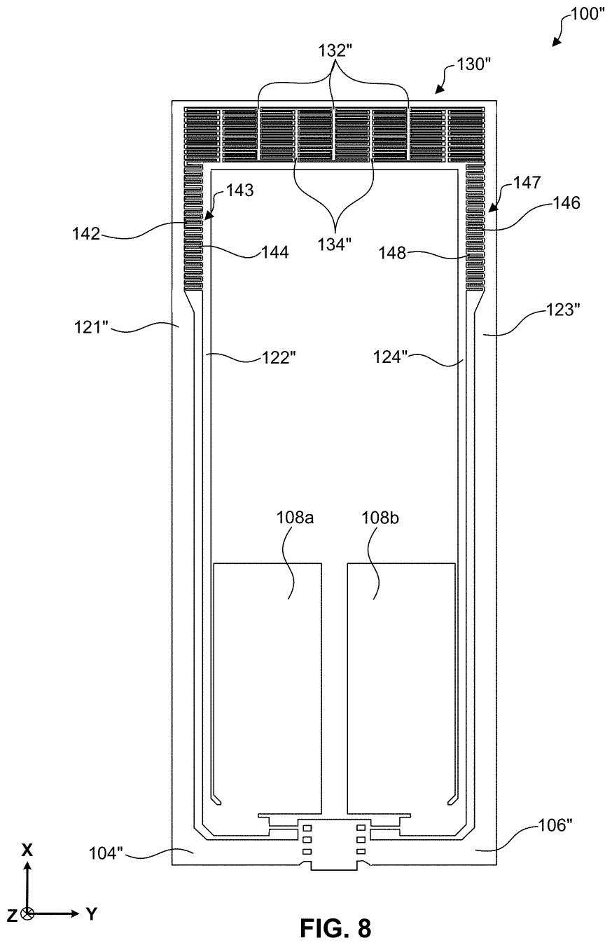

Proof mass 108 can be a MEMS suspended resonator configured to provide a reference resonant frequency for sensor 100. Proof mass 108 can be coupled to anchor 102 and disposed at a first distance 109 from anchor 102. In some embodiments, first distance 109 can be based on a distance between the center of mass 103 of anchor 102 and the center of mass 107 of proof mass 108. In some embodiments, first distance 109 can be based on a distance between a point of anchor 102 closest to proof mass 108. In some embodiments, proof mass 108 can have a mass of about 2 μg to about 6 μg. In some embodiments, proof mass 108 can have a resonant frequency of about 5 kHz to about 50 kHz. In some embodiments, as shown in FIG. 2, anchor 102 and proof mass 108 can have a greater depth (e.g., thickness along Z-axis) than sense structure 130. In some embodiments, as shown in FIG. 8, proof mass 108 can include a first proof mass 108a and a second proof mass 108b. For example, first proof mass 108a and second proof mass 108b can be spatially separate (e.g., adjacent) and oscillating independently of each other.

As shown in FIGS. 1 and 2, first and second finger legs 122, 124 can bow along a Z-axis in some embodiments. In some bowed embodiments, first and second finger legs 122, 124 can include a coating on a top exterior surface. For example, the coating can include an oxide (e.g., silicon oxide, silicon nitride, etc.), a metal, a dielectric, or any other material having a different coefficient of thermal expansion (CTE) than the material forming first and second finger legs 122, 124. In some embodiments, first and second finger legs 122, 124 can bow about 1 μm to about 10 μm along the Z-axis.

Alternatively, in some embodiments, first and second frame legs 121, 123 can be bowed and can allow first and second frames 104, 106, respectively, to bow along the Z-axis, rather than first and second finger legs 122, 124. In such embodiments, first and second frame legs 121, 123 can include a coating on a top exterior surface. For example, the coating can include an oxide (e.g., silicon oxide, silicon nitride, etc.), a metal, a dielectric, or any other material having a different coefficient of thermal expansion (CTE) than the material forming first and second frame legs 121, 123. In some embodiments, first and second frame legs 121, 123 can bow about 1 μm to about 10 μm along the Z-axis.

In some embodiments, as shown in FIGS. 1 and 2, first and second finger legs 122, 124 can include first and second proof mass linkages 110, 112, respectively. First and second proof mass linkages 110, 112 can function as springs and can be configured to reduce or lower a stiffness of first and second finger legs 122, 124 and provide greater oscillation (e.g., amplitude) of movable finger(s) 134 of sense structure 130 during, for example, high-g shock conditions. In some embodiments, first and second frame legs 121, 123 can include one or more linkages, similar to first and second proof mass linkages 110, 112, respectively.

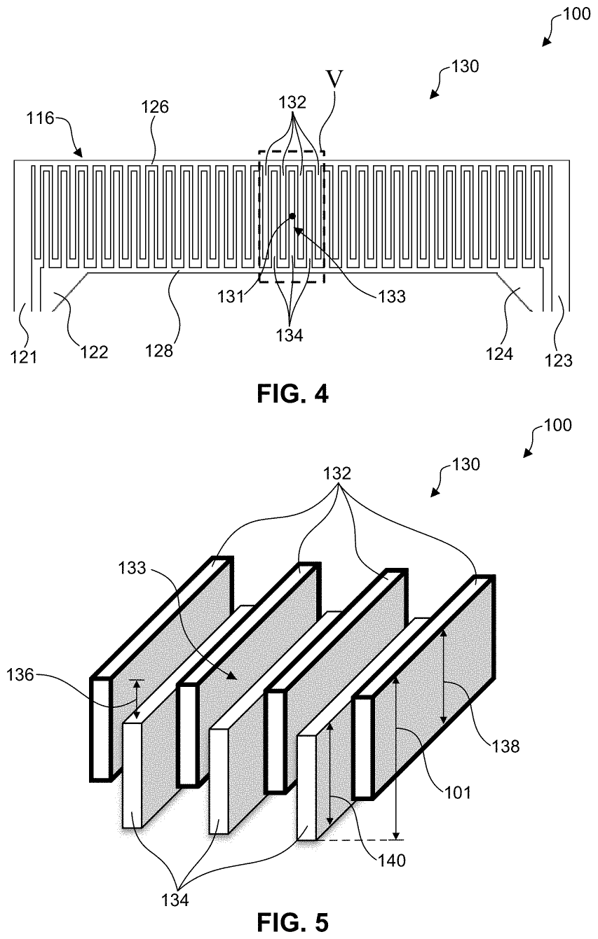

FIG. 3 illustrates a schematic cross-sectional view of sense structure 130 along a transverse centerline perpendicular to longitudinal axis (LA), according to an embodiment. FIG. 4 illustrates an enlarged partial schematic top view of sense structure 130, according to an embodiment. FIG. 5 illustrates an enlarged partial schematic perspective view of sense structure 130, according to an embodiment.

As shown in FIGS. 1-5, sense structure 130 can be a suspended interdigitated resonator configured to provide an area-varying capacitive measurement for sensor 100. Sense structure 130 can include at least one fixed finger 132, at least one movable finger 134, and a first capacitance area 133 (e.g., overlapping area between fixed finger 132 and movable finger 134). Fixed finger(s) 132 and movable finger(s) 134 can be configured to measure first capacitance area 133 by a sense motion change in the finger (plate) area based a length of fixed finger(s) 132 and a height offset between fixed finger(s) 132 and movable finger(s) 134. For example, as shown in FIG. 5, fixed finger(s) 132 can be arranged adjacent to movable finger(s) 134 and can act as a transducer (e.g., capacitive sensor) and measure sense motion (e.g., acceleration) of movable finger(s) 134 relative to fixed finger(s) 132 as a function of change in capacitance due to the change in overlapped finger area between fixed finger(s) 132 and movable finger(s) 134.

In some embodiments, at least one of movable finger(s) 134 and fixed finger(s) 132 can be bowed and the other one can be flat and not bowed (e.g., flat or parallel along an XY-plane). For example, movable finger(s) 134 can be bowed while fixed finger(s) 132 can be flat and not bowed (e.g., flat or parallel along an XY-plane). In some embodiments, fixed finger(s) 132 and movable finger(s) 134 can have the same height (e.g., along the Z-axis), for example, about 15 μm, and movable finger(s) 134 can include a CTE coating (e.g., silicon oxide) on a top exterior surface different from a bulk material (e.g., silicon) of the sense structure 130. In other embodiments, fixed finger(s) 132 can be bowed while movable finger(s) 134 can be flat and not bowed (e.g., flat or parallel along an XY-plane). For example, fixed finger(s) 132 and movable finger(s) 134 can have the same height (e.g., along the Z-axis), for example, about 15 μm, and fixed finger(s) 132 can include a CTE coating (e.g., silicon oxide) on a top exterior surface different from a bulk material (e.g., silicon) of the sense structure 130.

Sense structure 130 can be disposed at a distal end 116 of sensor 100. Sense structure 130 can be coupled to anchor 102 via first frame leg 121, first finger leg 122, second frame leg 123, and second finger leg 124, and disposed at a second distance 111 from anchor 102. In some embodiments, first and second frame legs 121, 123 can be fixed and first and second finger legs 122, 124 can be bowed. In some embodiments, second distance 111 can be based on a distance between the center of mass 103 of anchor 102 and the center of mass 131 of sense structure 130. In some embodiments, sense structure 130 can have a mass of about 2 μg to about 6 μg. In some embodiments, sense structure 130 can have a resonant frequency of about 5 kHz to about 15 kHz. For example, movable finger(s) 134 (e.g., bowed) can have a resonant frequency of about 5 kHz to about 15 kHz. As shown in FIG. 3, sense structure 130 can have a first height 101. In some embodiments, first height 101 can be about 10 μm to about 50 μm. For example, first height 101 can be about 15 μm. In some embodiments, first height 101 can be no greater than about 15 μm.

As shown in FIGS. 3-5, fixed finger(s) 132 can be coupled to first and second frame legs 121, 123. In some embodiments, first and second frame legs 121, 123 and fixed finger(s) 132 can be configured to remain spatially fixed and can act as a reference (e.g., a reference for an area-varying capacitive transducer) for movable finger 134(s) at a proximal end 128 of sense structure 130 to conduct capacitive measurements (e.g., area-varying). Movable finger(s) 134 at sense structure proximal end 128 can be coupled to first and second (e.g., bowed) finger legs 122, 124. In some embodiments, movable finger(s) 134 can have a resonant frequency of about 5 kHz to about 15 kHz. In some embodiments, as shown in FIG. 1, movable finger(s) 134 at sense structure proximal end 128 can include a plurality of movable fingers coupled to second finger legs 122, 124, and fixed finger(s) 132 at sense structure distal end 126 can include a plurality of fixed fingers coupled to first and second frame legs 121, 123. For example, the plurality of movable fingers 134 can be a plurality of movable comb fingers, and the plurality of fixed fingers 132 can be a plurality of fixed comb fingers interdigitated with movable fingers 134.

In some embodiments, as shown in FIG. 8, sense structure 130 can include at least one second fixed finger 142 and at least one second movable finger 144 disposed between first and second distances 109, 111. As such, second fixed finger(s) 142 and second movable finger(s) 144 are disposed between sense structure proximal end 128 and the center of mass 107 of the proof mass 108. For example, second fixed and movable fingers 142, 144 can be configured to measure a second capacitance area 143 (e.g. area-varying capacitive sensing).

As shown in FIGS. 3 and 5, in some bowed embodiments, due to the bowed nature (e.g., different CTE coating) of first and second finger legs 122, 124, a height difference 136 can be created between fixed finger(s) 132 and movable finger(s) 134 in first capacitance area 133. Height difference 136 can improve sense motion amplification and lower capacitance of sense structure 130 and, thus, lower a noise density of sensor 100. Further, height difference 136 can provide directionality (e.g., vector) of the movable finger(s) 134 (e.g., acceleration direction) due to its asymmetric arrangement (e.g., height offset) with fixed finger(s) 132 and first capacitance area 133. As shown in FIG. 3, fixed finger(s) 132 can include a first height 138 and movable finger(s) 134 can include a second height 140. In some embodiments, first height 138 and second height 140 can be the same. For example, fixed finger(s) 132 and movable finger(s) 134 can have a height of about 15 μm. In some embodiments, first and second heights 138, 140 can be no greater than about 15 μm.

In some embodiments, a ratio of first distance 109 and second distance 111 (i.e., first distance 109 divided by second distance 111) can be selected to reduce a noise density of sensor 100, for example, to reduce a noise density to no greater than about 130 μg Hz^{-1/2}. In some embodiments, the ratio can be between about 0.2 to about 0.6. In some embodiments, the ratio can be configured to allow deflection of movable finger(s) 134 at least about 1 μm relative to fixed finger(s) 132 (e.g., along the Z-axis) under an applied force (e.g., acceleration), for example, high-g acceleration of sensor 100. In some embodiments, the ratio can be between about 0.25 to about 0.45 and can be configured to allow deflection of movable finger(s) 134 at least about 3 μm relative to fixed finger(s) 132 (e.g., along the Z-axis) under an applied force (e.g., acceleration), for example, high-g acceleration of sensor 100. In some embodiments, the ratio can be between about 0.25 to about 0.45 and can be configured to reduce a noise density of the sensor to no greater than about 130 μg Hz^{-1/2}.

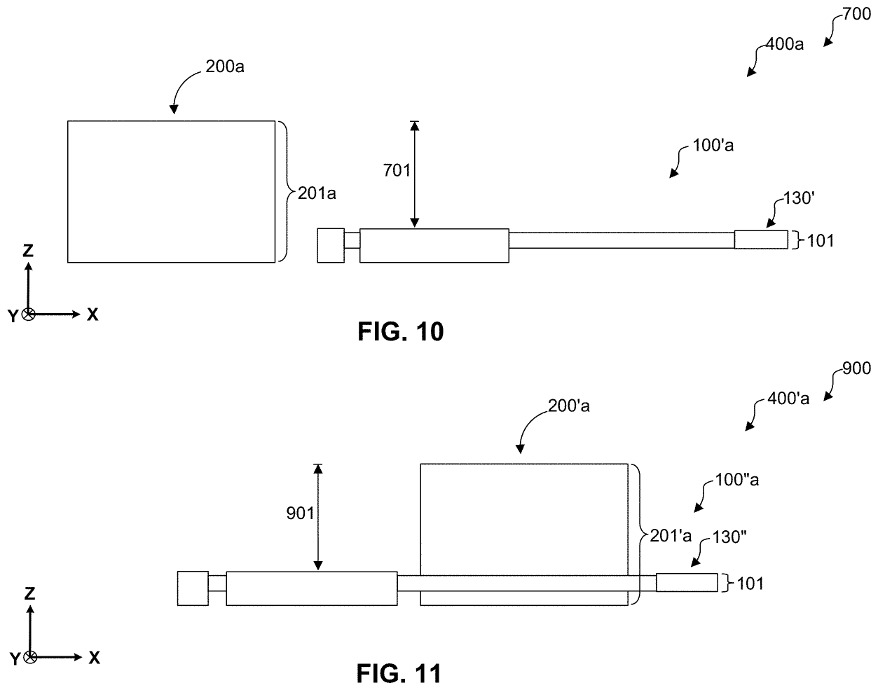

In some embodiments, as shown in FIG. 8, fixed finger(s) 132 and movable finger(s) 134 can extend along a portion of first and second frame legs 121, 123 and first and second finger legs 122, 124, respectively. In some embodiments, sense structure 130 can have first height 101 perpendicular to longitudinal axis (LA) of sensor 100 and can be configured to reduce a noise density in sensor 100. For example, first height 101 can be less than a second height (e.g., second height 201a, 201b or third height 301a, 301b) of a second sensor, for example, X-axis sensor 200a, 200b or Y-axis sensor 300a, 300b, or proof mass 108, as shown in FIGS. 7, 9, 10, and 11. In some embodiments, a second sensor, for example, X-axis sensor 200a, 200b or Y-axis sensor 300a, 300b, can be disposed between proof mass 108 and sense structure 130 of sensor 100 as shown in FIGS. 10 and 11. In some embodiments, sensor 100 can include a processor, for example, processor 500, coupled to proof mass 108 and movable finger(s) 134 of sense structure 130. For example, the processor can be configured to measure an acceleration based on a sensed area-varying capacitance change of first capacitance area 133 due to movement of movable finger(s) 134 and based on a reference resonant frequency of proof mass 108.

In some embodiments, sensor 100 can include an alternative sense structure 130 for increased sensitivity. For example, comb finger(s) can be used. In some embodiments, sensor 100 can be combined with additional sensors (e.g., adjacent) for differential and/or tri-axial measurements.

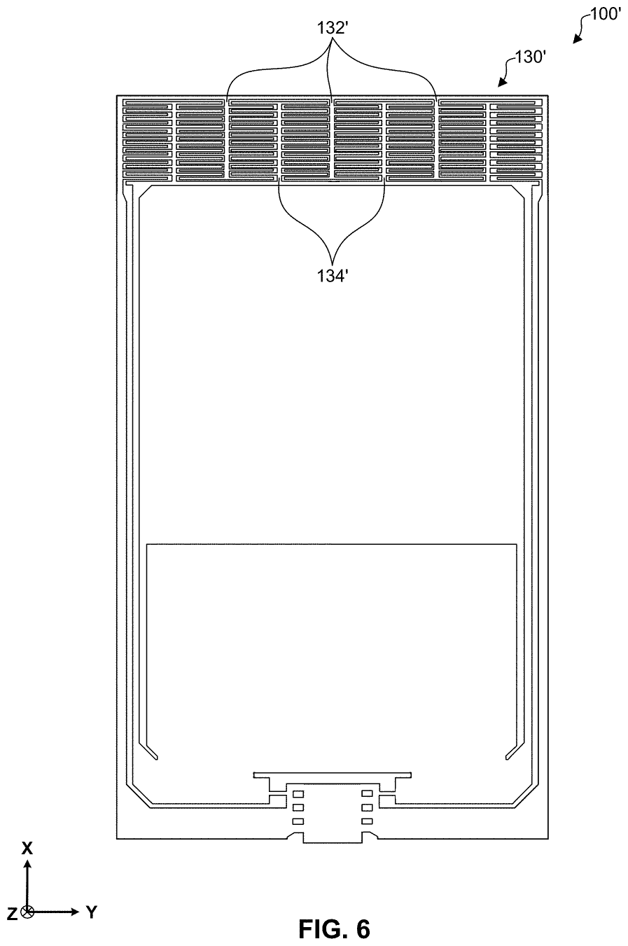

FIG. 6 illustrates a schematic top view of sensor 100′, according to an exemplary embodiment. The embodiments of sensor 100 shown in FIGS. 1-5 and the embodiments of sensor 100′ shown in FIG. 6 are similar. Similar reference numbers are used to indicate similar features of the embodiments of sensor 100 shown in FIGS. 1-5 and the similar features of the embodiments of sensor 100′ shown in FIG. 6. Description of sensor 100′ is omitted in the interest of brevity. One difference between the embodiments of sensor 100 shown in FIGS. 1-5 and the embodiments of sensor 100′ shown in FIG. 6 is that sensor 100′ includes sense structure 130′, which includes fixed comb finger(s) 132′ and movable comb finger(s) 134′, rather than sense structure 130 with fixed finger(s) 132 and movable finger(s) 134 of sensor 100 shown in FIGS. 1-5.

As shown in FIG. 6, fixed comb finger(s) 132′ and movable comb finger(s) 134′ can be interdigitated along sense structure 130′. In some embodiments, the movable comb finger(s) 134′ can have a resonant frequency of about 5 kHz to about 15 kHz. In some embodiments, sensor 100′ can be a Z-axis accelerometer.

FIG. 8 illustrates a schematic top view of sensor 100″, according to an exemplary embodiment. The embodiments of sensor 100 shown in FIGS. 1-5 and the embodiments of sensor 100″ shown in FIG. 8 are similar. Similar reference numbers are used to indicate similar features of the embodiments of sensor 100 shown in FIGS. 1-5 and the similar features of the embodiments of sensor 100″ shown in FIG. 8. Description of sensor 100″ is omitted in the interest of brevity. One difference between the embodiments of sensor 100 shown in FIGS. 1-5 and the embodiments of sensor 100″ shown in FIG. 8 is that sensor 100″ includes sense structure 130″, which includes fixed comb finger(s) 132″, movable comb finger(s) 134″, first and second extended fixed fingers 142, 146 coupled to first and second fixed frame legs 121″, 123″, first and second extended movable fingers 144, 148 coupled to first and second (e.g., bowed) finger(s) legs 122″, 124″, and second capacitance areas 143, 147, respectively, and first proof mass 108a and second proof mass 108b, rather than sense structure 130 with fixed finger(s) 132 and movable finger(s) 134 and proof mass 108 of sensor 100 shown in FIGS. 1-5.

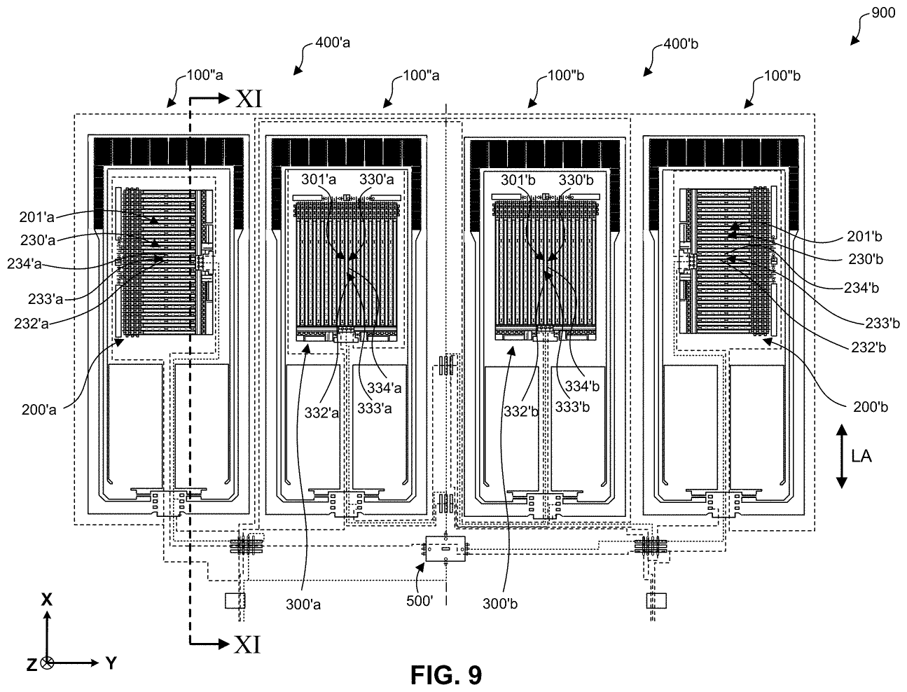

As shown in FIG. 8, fixed comb finger(s) 132″, movable comb finger(s) 134″, first and second extended fixed fingers 142, 146, and first and second extended movable fingers 144, 148 can be interdigitated along sense structure 130″. In some embodiments, movable comb finger(s) 134″ and first and second extended movable fingers 144, 148 can be bowed. Alternatively, in some embodiments, fixed comb finger(s) 132″ and first and second extended fixed fingers 142, 146 can be bowed. In some embodiments, sensor 100″ can be configured to receive a second sensor between first and second proof masses 108a, 108b and sense structure 130″. In some embodiments, the movable comb finger(s) 134″ and first and second extended (e.g., bowed) movable fingers 144, 148 can have a resonant frequency of about 5 kHz to about 15 kHz. In some embodiments, sensor 100″ can be a Z-axis accelerometer. As shown in FIGS. 8 and 9, an advantage of sensor 100″ is an extended sense area (e.g., sense structure 130″) that includes second capacitance areas 143, 147 and allows sensor 100″ to be extended longitudinally, for example, to accommodate a separate sensor (e.g., first and second X-axis sensors 200′a, 200′b and first and second Y-axis sensors 300′a, 300′b shown in FIGS. 9 and 11). Additionally, a further advantage of sensor 100″ is the use of first proof mass 108a and second proof mass 108b, separated spatially, that can accommodate connections (e.g., leads) to a separate sensor (e.g., first and second X-axis sensors 200′a, 200′b and first and second Y-axis sensors 300′a, 300′b shown in FIGS. 9 and 11) disposed inside sensor 100″ and act as two independent reference resonant frequencies.

Exemplary Differential Sensor Systems

FIG. 7 illustrates a schematic top view of differential sensor system 700, according to an exemplary embodiment. FIG. 10 illustrates a schematic longitudinal cross-sectional view of differential sensor system 700. The embodiments of sensor 100′ shown in FIG. 6 and the embodiments of differential sensor system 700 shown in FIG. 7 are similar. Similar reference numbers are used to indicate similar features of the embodiments of sensor 100′ shown in FIG. 6 and the similar features of the embodiments of differential sensor system 700 shown in FIG. 7. One difference between the embodiments of sensor 100′ shown in FIG. 6 and the embodiments of differential sensor system 700 shown in FIG. 7 is that differential sensor system 700 includes first and second sensor systems 400a, 400b, which include first and second Z-axis sensors 100′a, 100′b, first and second X-axis sensors 200a, 200b, and first and second Y-axis sensors 300a, 300b, respectively, and processor 500, rather than just sensor 100′ shown in FIG. 6.

Further, as shown in FIGS. 7 and 10, first sensor system 400a includes first X-axis sensor 200a with a second height 201a for second sense structure 230a and first Z-axis sensor 100′a with first height 101 for sense structure 130′. As shown in FIG. 10, first height 101 is much less than second height 201a (e.g., along a Z-axis) and first X-axis sensor 200a and first Z-axis sensor 100′a can have a height difference 701. The height difference 701 can reduce an overall noise of differential sensor system 700 and reduce damage or failure due to deflection since sense structure 130′ has a smaller (reduced) overlapping area relative to second sense structure 230a and first height 101 reduces unwanted contact with a floor, a ceiling, or other components of differential sensor system 700 during high-g shock conditions relative to second height 201a of first X-axis sensor 200a. As shown in FIGS. 7 and 10, an advantage of differential sensor system 700 is the difference in height (e.g., height difference 701) between first and second Z-axis sensors 100′a, 100′b and corresponding first and second X-axis sensors 200a, 200b and first and second Y-axis sensors 300a, 300b that provides an overall lower noise (e.g., noise density) for differential sensor system 700. Additionally, a further advantage of differential sensor system 700 is the combination of multi-axis sensors, for example, first and second Z-axis sensors 100′a, 100′b, first and second X-axis sensors 200a, 200b, first and second Y-axis sensors 300a, 300b, and processor 500 for differential and/or tri-axial measurements.

As shown in FIGS. 7 and 10, differential sensor system 700 can be configured to measure a differential measurement between first sensor system 400a and second sensor system 400b. First sensor system 400a can include first Z-axis sensor 100′a adjacent first X-axis sensor 200a and first Z-axis sensor 100′a adjacent first Y-axis sensor 300a. Second sensor system 400b can include second Z-axis sensor 100′b adjacent second X-axis sensor 200b and second Z-axis sensor 100′b adjacent second Y-axis sensor 300b. First and second X-axis sensors 200a, 200b can include second height 201a, 201b, second sense structure 230a, 230b, fixed finger(s) 232a, 232b, movable finger(s) 234a, 234b, and second capacitance area 233a, 233b, respectively. First and second Y-axis sensors 300a, 300b can include third height 301a, 301b, third sense structure 330a, 330b, fixed finger(s) 332a, 332b, movable finger(s) 334a, 334b, and third capacitance area 333a, 333b, respectively.

In some embodiments, second height 201a, 201b and third height 301a, 301b can be perpendicular to longitudinal axis (LA) of first and second Z-axis sensors 100′a, 100′b. In some embodiments, first height 101 of first and second Z-axis sensors 100′a, 100′b can be less than second height 201a, 201b of first and second X-axis sensors 200a, 200b and can be configured to reduce a noise density in differential sensor system 700 (e.g., due to the difference in height). For example, first height 101 can be no greater than about 15 μm and second height 201a, 201b can be no less than about 50 μm, and the noise density in differential sensor system 700 can be reduced to no greater than about 130 μg Hz^{-1/2}. In some embodiments, first height 101 of first and second Z-axis sensors 100′a, 100′b can be less than third height 301a, 301b of first and second Y-axis sensors 300a, 300b and can be configured to reduce a noise density in differential sensor system 700 (e.g., due to the difference in height). For example, first height 101 can be no greater than about 15 μm and third height 301a, 301b can be no less than about 50 μm, and the noise density in differential sensor system 700 can be reduced to no greater than about 130 μg Hz^{-1/2}.

Processor 500 can be coupled to first and second sensor systems 400a, 400b and can be configured to measure a differential measurement between first and second sensor systems 400a, 400b. For example, first Z-axis sensor 100′a, first X-axis sensor 200a, second Z-axis sensor 100′b, and second X-axis sensor 200b can be arranged to be identical except that movable fingers (e.g., movable comb finger(s) 134′, movable finger(s) 234a) are bowed for both first Z-axis sensor 100′a and first X-axis sensor 200a while fixed fingers (e.g., fixed comb finger(s) 132′, fixed finger(s) 232a) are flat and, symmetrically, fixed fingers (e.g., fixed comb finger(s) 132′, fixed finger(s) 232a) are bowed for both second Z-axis sensor 100′b and second X-axis sensor 200b while movable fingers (e.g., movable comb finger(s) 134′, movable finger(s) 234a) are flat, such that a comparison of area-varying capacitive measurements can be made between first and second sensor systems 400a, 400b. In some embodiments, first and second sensor systems 400a, 400b can each be a tri-axis MEMS accelerometer.

FIG. 9 illustrates a schematic top view of differential sensor system 900, according to an exemplary embodiment. FIG. 11 illustrates a schematic longitudinal cross-sectional view of differential sensor system 900. The embodiments of differential sensor system 700 shown in FIG. 7 and the embodiments of differential sensor system 900 shown in FIG. 9 are similar. Similar reference numbers are used to indicate similar features of the embodiments of differential sensor system 700 shown in FIG. 7 and the similar features of the embodiments of differential sensor system 900 shown in FIG. 9. Description of differential sensor system 900 is omitted in the interest of brevity. One difference between the embodiments of differential sensor system 700 shown in FIG. 7 and the embodiments of differential sensor system 900 shown in FIG. 9 is that differential sensor system 900 includes first and second sensor systems 400′a, 400′b, which include first and second Z-axis sensors 100″a, 100″b, which are similar to sensor 100″ shown in FIG. 8 rather than sensor 100′ shown in FIG. 6, and first and second X-axis sensors 200′a, 200′b and first and second Y-axis sensors 300′a, 300′b are disposed inside first and second Z-axis sensors 100″a, 100″b, respectively, rather than adjacent to (e.g., outside of) first and second Z-axis sensors 100′a, 100′b of differential sensor system 700 shown in FIG. 7.

Further, as shown in FIGS. 9 and 11, first sensor system 400′a includes first X-axis sensor 200′a with a second height 201′a for second sense structure 230′a and first Z-axis sensor 100″a with first height 101 for sense structure 130″. As shown in FIG. 11, first height 101 is much less than second height 201′a (e.g., along a Z-axis) and first X-axis sensor 200′a and first Z-axis sensor 100″a can have a height difference 901. The height difference 901 can reduce an overall noise of differential sensor system 900 and reduce damage or failure due to deflection since sense structure 130″ has a smaller (reduced) overlapping area relative to second sense structure 230′a and first height 101 reduces unwanted contact with a floor, a ceiling, or other components of differential sensor system 900 during high-g shock conditions relative to second height 201′a of first X-axis sensor 200′a. As shown in FIGS. 9 and 11, an advantage of differential sensor system 900 is the difference in height (e.g., height difference 901) between first and second Z-axis sensors 100′a, 100′b and corresponding first and second X-axis sensors 200a, 200b and first and second Y-axis sensors 300a, 300b that provides an overall lower noise (e.g., noise density) for differential sensor system 900. Additionally, a further advantage of differential sensor system 900 is the combination of multi-axis sensors, for example, first and second Z-axis sensors 100″a, 100″b, first and second X-axis sensors 200′a, 200′b, first and second Y-axis sensors 300′a, 300′b, and processor 500′ for differential and/or tri-axial measurements.

As shown in FIGS. 9 and 11, first and second X-axis sensors 200′a, 200′b are disposed between first and second proof mass 108a, 108b and sense structure 130″ of first and second Z-axis sensors 100″a, 100″b, respectively, and first and second Y-axis sensors 300′a, 300′b are disposed between first and second proof mass 108a, 108b and sense structure 130″ of first and second Z-axis sensors 100″a, 100″b, respectively.

Processor 500′ can be coupled to first and second sensor systems 400′a, 400′b and can be configured to measure a differential measurement between first and second sensor systems 400′a, 400′b. For example, first Z-axis sensor 100″a, first X-axis sensor 200′a, second Z-axis sensor 100″b, and second X-axis sensor 200′b can be arranged to be identical except that movable fingers (e.g., movable comb finger(s) 134″, movable finger(s) 234′a) are bowed for both first Z-axis sensor 100″a and first X-axis sensor 200′a while fixed fingers (e.g., fixed comb finger(s) 132″, fixed finger(s) 232′a) are flat and, symmetrically, fixed fingers (e.g., fixed comb finger(s) 132″, fixed finger(s) 232′a) are bowed for both second Z-axis sensor 100″b and second X-axis sensor 200′b while movable fingers (e.g., movable comb finger(s) 134″, movable finger(s) 234′a) are flat, such that a comparison of area-varying capacitive measurements can be made between first and second sensor systems 400′a, 400′b. In some embodiments, first and second sensor systems 400′a, 400′b can each be a tri-axis MEMS accelerometer.

It is to be understood that the phraseology or terminology herein is for the purpose of description and not of limitation, such that the terminology or phraseology of the present specification is to be interpreted by those skilled in relevant art(s) in light of the teachings herein.

The term “substrate” as used herein describes a material onto which material layers are added. In some embodiments, the substrate itself may be patterned and materials added on top of it may also be patterned, or may remain without patterning.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical, or other forms of propagated signals, and others. Further, firmware, software, routines, and/or instructions may be described herein as performing certain actions. However, it should be appreciated that such descriptions are merely for convenience and that such actions in fact result from computing devices, processors, controllers, or other devices executing the firmware, software, routines, and/or instructions.

The following examples are illustrative, but not limiting, of the embodiments of this disclosure. Other suitable modifications and adaptations of the variety of conditions and parameters normally encountered in the field, and which would be apparent to those skilled in the relevant art(s), are within the spirit and scope of the disclosure.

While specific embodiments of the invention have been described above, it will be appreciated that the invention may be practiced otherwise than as described. The description is not intended to limit the invention.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein.

The breadth and scope of the present invention should not be limited by any of the above-described exemplary embodiments, but should be defined only in accordance with the following claims and their equivalents.

What is claimed is:

1. A sensor having a proximal end and a distal end, the sensor comprising:
an anchor disposed at the proximal end;
a proof mass coupled to the anchor and disposed at a first distance from the anchor; and
a fixed finger and a movable finger coupled to the anchor and disposed at a second distance from the anchor at the distal end, wherein the fixed and movable fingers are configured to measure a first capacitance area,
wherein a ratio of the first distance over the second distance is between about 0.2 to about 0.6 and the ratio is configured to deflect the movable finger at least about 1 μm relative to the fixed finger.

2. The sensor of claim 1, wherein the ratio is between about 0.25 to about 0.45 and is configured to deflect the movable finger at least about 3 μm relative to the fixed finger.

3. The sensor of claim 1, wherein the ratio is between about 0.25 to about 0.45 and is configured to reduce a noise density of the sensor to no greater than about 130 μg Hz^{-1/2}.

4. The sensor of claim 1, further comprising a bowed region between the fixed and movable fingers and the anchor.

5. The sensor of claim 4, wherein the bowed region comprises a linkage configured to lower a stiffness of the movable finger.

6. The sensor of claim 4, wherein the fixed and movable fingers extend along a portion of the bowed region.

7. The sensor of claim 1, wherein:
the fixed finger comprises a first height and the movable finger comprises a second height; and
the first and second heights are no greater than about 15 microns.

8. The sensor of claim 1, wherein:
the fixed finger comprises a first height and the movable finger comprises a second height; and
the first and second heights are offset from each other by a height difference.

9. The sensor of claim 1, wherein the fixed finger comprises a plurality of fixed comb fingers and the movable finger comprises a plurality of movable comb fingers.

10. The sensor of claim 1, further comprising a second fixed finger and a second movable finger disposed between the first and second distances and configured to measure a second capacitance area.

11. The sensor of claim 1, wherein the proof mass comprises a first proof mass and a second proof mass.

12. The sensor of claim 1, wherein the movable finger has a resonant frequency of about 5 kHz to about 15 kHz.

13. The sensor of claim 1, wherein the sensor is a Z-axis accelerometer.

14. A sensor system comprising:
a first sensor, the first sensor comprising:
a proof mass; and
a first sense structure having a first height perpendicular to a longitudinal axis of the first sensor and coupled to the proof mass, wherein the first sense structure comprises a fixed finger and a movable finger and is configured to measure capacitance area changes between the fixed and movable fingers; and
a second sensor adjacent the first sensor, the second sensor comprising a second sense structure having a second height perpendicular to the longitudinal axis of the first sensor,
wherein the first height is less than the second height and configured to reduce a noise density in the sensor system.

15. The sensor system of claim 14, wherein the first height is no greater than about 15 microns.

16. The sensor system of claim 14, wherein the second sensor is disposed between the proof mass and the first sense structure of the first sensor.

17. The sensor system of claim 14, wherein the first sensor is a Z-axis accelerometer and the second sensor is an X-axis accelerometer or a Y-axis accelerometer.

18. A differential sensor system comprising:
a first sensor system, the first sensor system comprising:
a first sensor comprising a first sense structure having a first height perpendicular to a longitudinal axis of the first sensor and coupled to a proof mass, wherein the first sense structure is configured to measure capacitance area changes between a fixed comb finger and a bowed movable comb finger; and
a second sensor comprising a second sense structure having a second height perpendicular to the longitudinal axis of the first sensor, wherein the first height is less than the second height;
a second sensor system, the second sensor system comprising:
a third sensor comprising a third sense structure having a third height perpendicular to a longitudinal axis of the third sensor and coupled to a second proof mass, wherein the third sense structure is configured to measure capacitance area changes between a bowed fixed comb finger and a movable comb finger; and
a fourth sensor comprising a fourth sense structure having a fourth height perpendicular to the longitudinal axis of the third sensor, wherein the third height is less than the fourth height; and
a processor coupled to the first and second sensor systems,
wherein the processor is configured to measure a differential measurement between the first and second sensor systems.

19. The differential sensor system of claim 18, wherein:
the second sensor is disposed between the proof mass and the first sense structure of the first sensor; and
the fourth sensor is disposed between the second proof mass and the third sense structure of the third sensor.

20. The differential sensor system of claim 19, wherein:
the first sensor is a Z-axis accelerometer;
the second sensor is an X-axis accelerometer or a Y-axis accelerometer;
the third sensor is a Z-axis accelerometer;
the fourth sensor is an X-axis accelerometer or a Y-axis accelerometer.
